(19) United States
(12) Patent Application Publication
(10) Pub. No.: US 2024/0224252 A1
(43) Pub. Date: Jul. 4, 2024

(54) FULL-DUPLEX DEFAULT BEAM CONFIGURATION

(71) Applicant: QUALCOMM Incorporated, San Diego, CA (US)

(72) Inventors: Qian Zhang, Basking Ridge, NJ (US); Yan Zhou, San Diego, CA (US); Muhammad Sayed Khairy Abdelghaffar, San Jose, CA (US)

(21) Appl. No.: 18/148,320

(22) Filed: Dec. 29, 2022

(51) Int. Cl. H04W 72/044; H04L 5/00; H04L 5/14

(52) U.S. Cl. CPC H04W 72/046; H04L 5/0035; H04L 5/14

(57) ABSTRACT

Methods, systems, and devices for wireless communications are described. A wireless communications device may select a first set of one or more configured or default beams for full-duplex communications with one or more transmission reception points (TRPs) during one or more full-duplex symbol periods. The first set of one or more default beams may include one or more uplink default beams, one or more downlink default beams, or a pair of uplink and downlink default beams. The wireless communications device may then communicate with the one or more TRPs using the first set of one or more default beams during at least one symbol period of the one or more full-duplex symbol periods.

### FIELD OF TECHNOLOGY

The following relates to wireless communications, including full-duplex default beam configuration.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some systems, some devices may support full-duplex or dynamic time-division duplexing (TDD) communication using beamformed signaling. In such full-duplex scenarios, devices may experience cross-link interference (CLI) from another one or more of the devices, self-interference, or both.

### SUMMARY

The described techniques relate to improved methods, systems, devices, and apparatuses that support sub-band full-duplex (SBFD) default beam configuration. For example, the described techniques provide for selecting a configured or “default” beam for full-duplex communications deployments. In such examples, a full-duplex or dynamic time-division duplexing (TDD) capable device may support a sub-band configuration according to which the device may transmit via a first set of one or more sub-bands and receive via a second set of one or more sub-bands. In such deployments, a device may select a first set of one or more configured or default beams for full-duplex communications with one or more transmission reception points (TRPs) during one or more full-duplex symbol periods. The first set of one or more default beams may include one or more uplink default beams, one or more downlink default beams, or a pair of uplink and downlink default beams. The wireless communications device may then communicate with the one or more TRPs using the first set of one or more default beams during at least one symbol period of the one or more full-duplex symbol periods.

A method for wireless communication is described. The method may include selecting a first set of one or more default beams for full-duplex communications, the first set of one or more default beams being configured for communications with one or more TRPs during one or more full-duplex symbol periods and communicating with the one or more TRPs using the first set of one or more default beams during at least one symbol period of the one or more full-duplex symbol periods.

An apparatus for wireless communication is described. The apparatus may include a processor, memory coupled with the processor, and instructions stored in the memory. The instructions may be executable by the processor to cause the apparatus to select a first set of one or more default beams for full-duplex communications, the first set of one or more default beams being configured for communications with one or more TRPs during one or more full-duplex symbol periods and communicate with the one or more TRPs using the first set of one or more default beams during at least one symbol period of the one or more full-duplex symbol periods.

Another apparatus for wireless communication is described. The apparatus may include means for selecting a first set of one or more default beams for full-duplex communications, the first set of one or more default beams being configured for communications with one or more TRPs during one or more full-duplex symbol periods and means for communicating with the one or more TRPs using the first set of one or more default beams during at least one symbol period of the one or more full-duplex symbol periods.

A non-transitory computer-readable medium storing code for wireless communication is described. The code may include instructions executable by a processor to select a first set of one or more default beams for full-duplex communications, the first set of one or more default beams being configured for communications with one or more TRPs during one or more full-duplex symbol periods and communicate with the one or more TRPs using the first set of one or more default beams during at least one symbol period of the one or more full-duplex symbol periods.

In some examples of the method, apparatuses, and non-transitory computer-readable medium described herein, communicating with the one or more TRPs may include operations, features, means, or instructions for communicating with at least two TRPs of the one or more TRPs, where the first set of one or more default beams includes two or more default uplink beams, each default uplink beam of the two or more default uplink beams being associated with a respective TRP of the at least two TRPs.

In some examples of the method, apparatuses, and non-transitory computer-readable medium described herein, communicating with the one or more TRPs may include operations, features, means, or instructions for communicating with at least two TRPs of the one or more TRPs, where the first set of one or more default beams includes two or more default downlink beams, each default uplink beam of the two or more default downlink beams being associated with a respective TRP of the at least two TRPs.

In some examples of the method, apparatuses, and non-transitory computer-readable medium described herein, communicating with the one or more TRPs may include operations, features, means, or instructions for communicating with a first TRP of the one or more TRPs, where the first set of one or more default beams includes one default uplink beam associated with the first TRP or one default downlink beam associated with the first TRP.

In some examples of the method, apparatuses, and non-transitory computer-readable medium described herein, the first set of one or more default beams includes a default beam pair, the default beam pair including one default uplink beam and one default downlink beam.

In some examples of the method, apparatuses, and non-transitory computer-readable medium described herein, the default beam pair including the one default uplink beam and the one default downlink beam may be configured for the full-duplex communications with at least one TRP of the one or more TRPs during the one or more full-duplex symbol periods.

Some examples of the method, apparatuses, and non-transitory computer-readable medium described herein may further include operations, features, means, or instructions for receiving a control message indicating the first set of one or more default beams, where the first set of one or more default beams may be identified based on receiving the control message.

In some examples of the method, apparatuses, and non-transitory computer-readable medium described herein, the control message includes a radio resource control (RRC) message, a medium access control-control element (MAC-CE), downlink control information (DCI), or any combination thereof.

Some examples of the method, apparatuses, and non-transitory computer-readable medium described herein may further include operations, features, means, or instructions for determining a lowest CORESET index value in a latest slot that precedes the one or more full-duplex symbol periods based on the latest slot and the one or more full-duplex symbol periods both being configured for the full-duplex communications, where the first set of one or more default beams may be identified based on a beam that may be associated with a lowest CORESET index value.

In some examples of the method, apparatuses, and non-transitory computer-readable medium described herein, the first set of one or more default beams may be different from a second set of one or more default beams used for communicating with the one or more TRPs during respective symbol periods configured for time-division duplexed (TDD) uplink communications or downlink communications.

Some examples of the method, apparatuses, and non-transitory computer-readable medium described herein may further include operations, features, means, or instructions for determining a lowest CORESET index value in a latest slot that precedes an uplink symbol period, a downlink symbol period, or a flexible symbol period based on the latest slot and the uplink symbol period, the downlink symbol period, or the flexible symbol period both being configured for TDD communications, where a second set of one or more default beams may be identified based on a beam that may be associated with a lowest CORESET index value.

In some examples of the method, apparatuses, and non-transitory computer-readable medium described herein, the full-duplex communications may be performed at a network entity during the one or more full-duplex symbol periods.

In some examples of the method, apparatuses, and non-transitory computer-readable medium described herein, the full-duplex communications include SBFD communications, fully overlapping full-duplex communications, partial overlapping full-duplex communications, or any combination thereof.

A method for wireless communication is described. The method may include transmitting a control message indicating a first set of one or more default beams for full-duplex communications, the first set of one or more default beams being configured for communications with a UE during one or more full-duplex symbol periods and communicating with the UE using the first set of one or more default beams during at least one symbol period of the one or more full-duplex symbol periods.

An apparatus for wireless communication is described. The apparatus may include a processor, memory coupled with the processor, and instructions stored in the memory. The instructions may be executable by the processor to cause the apparatus to transmit a control message indicating a first set of one or more default beams for full-duplex communications, the first set of one or more default beams being configured for communications with a UE during one or more full-duplex symbol periods and communicate with the UE using the first set of one or more default beams during at least one symbol period of the one or more full-duplex symbol periods.

Another apparatus for wireless communication is described. The apparatus may include means for transmitting a control message indicating a first set of one or more default beams for full-duplex communications, the first set of one or more default beams being configured for communications with a UE during one or more full-duplex symbol periods and means for communicating with the UE using the first set of one or more default beams during at least one symbol period of the one or more full-duplex symbol periods.

A non-transitory computer-readable medium storing code for wireless communication is described. The code may include instructions executable by a processor to transmit a control message indicating a first set of one or more default beams for full-duplex communications, the first set of one or more default beams being configured for communications with a UE during one or more full-duplex symbol periods and communicate with the UE using the first set of one or more default beams during at least one symbol period of the one or more full-duplex symbol periods.

In some examples of the method, apparatuses, and non-transitory computer-readable medium described herein, the first set of one or more default beams includes one or more default downlink beams or one or more default uplink beams, each default downlink beam of the one or more default downlink beams or each default uplink beam of the one or more default uplink beams being associated with a respective TRP.

In some examples of the method, apparatuses, and non-transitory computer-readable medium described herein, the first set of one or more default beams includes a default beam pair, the default beam pair including one default uplink beam and one default downlink beam and the default beam pair including the one default uplink beam and the one default downlink beam may be configured for the full-duplex communications with at least one TRP during the at least one symbol period.

In some examples of the method, apparatuses, and non-transitory computer-readable medium described herein, the control message includes a RRC message, a MAC-CE, DCI, or any combination thereof.

Some examples of the method, apparatuses, and non-transitory computer-readable medium described herein may further include operations, features, means, or instructions for determining a lowest control resource set (CORESET) index value in a latest slot that precedes the one or more full-duplex symbol periods based on the latest slot and the one or more full-duplex symbol periods both being configured for the full-duplex communications, where the first set of one or more default beams may be identified based on a beam that may be associated with a lowest CORESET index value.

Some examples of the method, apparatuses, and non-transitory computer-readable medium described herein may further include operations, features, means, or instructions for determining a lowest CORESET index value in a latest slot that precedes an uplink symbol period, a downlink symbol period, or a flexible symbol period based on the latest slot and the uplink symbol period, the downlink symbol period, or the flexible symbol period both being configured for TDD communications, where a second set of one or more default beams may be identified based on a beam that may be associated with a lowest CORESET index value.

### BRIEF DESCRIPTION OF THE DRAWINGS

FIGS. 1, 2, and 3 illustrate examples of wireless communications systems that support full-duplex default beam configuration in accordance with one or more aspects of the present disclosure.

FIG. 4 illustrates an example of a process flow that supports full-duplex default beam configuration in accordance with one or more aspects of the present disclosure.

FIGS. 5 and 6 illustrate block diagrams of devices that support full-duplex default beam configuration in accordance with one or more aspects of the present disclosure.

FIG. 7 illustrates a block diagram of a communications manager that supports full-duplex default beam configuration in accordance with one or more aspects of the present disclosure.

FIG. 8 illustrates a diagram of a system including a device that supports full-duplex default beam configuration in accordance with one or more aspects of the present disclosure.

FIGS. 9 and 10 illustrate block diagrams of devices that support full-duplex default beam configuration in accordance with one or more aspects of the present disclosure.

FIG. 11 illustrates a block diagram of a communications manager that supports full-duplex default beam configuration in accordance with one or more aspects of the present disclosure.

FIG. 12 illustrates a diagram of a system including a device that supports full-duplex default beam configuration in accordance with one or more aspects of the present disclosure.

FIGS. 13 and 14 illustrate flowcharts showing methods that support full-duplex default beam configuration in accordance with one or more aspects of the present disclosure.

### DETAILED DESCRIPTION

In some systems, one or more wireless communication devices may support full-duplex or flexible time-division duplexing (TDD) communications, according to which such devices may simultaneously transmit and receive or may switch between uplink and downlink communication across various time intervals, respectively. In some deployments, a full-duplex or dynamic TDD capable device may support a sub-band configuration according to which the device may transmit via a first set of one or more sub-bands and receive via a second set of one or more sub-bands, where the first and second sets of sub-bands may overlap or may be non-overlapping in the frequency domain. In such deployments, devices may also support beamformed communications including the indication of a “default” beam to reduce beam switch latency and overhead, allowing a device to use a preconfigured or default beam configuration to receive downlink communications in half-duplex scenarios. For example, a device may select a beam with a relatively highest reference signal receive power (RSRP) or signal quality as the default beam.

In some systems, however, one or more wireless communication devices may also support the full-duplex or flexible TDD communication, which may introduce challenges for selecting a default beam based on RSRP, because full-duplex systems may be associated with relatively higher levels of self-interference and/or cross-link interference as compared to some half-duplex deployments. A wireless communications device such as a network entity, therefore, may define a default beam for full-duplex communications using various techniques. For example, a network entity may indicate a downlink or uplink default beam, multiple default downlink beams or multiple default uplink beams (e.g., with each default beam of the multiple default beams being associated with a respective transmission reception point (TRP)), or a pair of default and uplink default beams (e.g., one downlink beam paired with one uplink beam) for full-duplex communications in a full-duplex slot via control signaling. In some other examples, the default beam may be implicitly determined based on a beam associated with the lowest control resource set (CORESET) index in the latest slot of the same slot type. For example, a user equipment (UE) or a network entity may determine the default beam for a sub-band full duplex (SBFD) slot based on the beam associated with the lowest CORESET index in the most recent SBFD slot.

Further, such default beam determinization may facilitate relatively greater adoption of full-duplex or dynamic TDD and full-duplex operation, which may provide other benefits to wireless communications systems. For example, full-duplex operation may support relatively longer uplink duty cycles, which may lead to latency reduction and improved uplink coverage. For example, in accordance with full-duplex operation, the UE may receive a downlink signal in “uplink only” slots, which may enable or otherwise facilitate latency savings. Further, full-duplex operation may increase system capacity, resource utilization, and spectrum efficiency and enable flexible and dynamic uplink or downlink resource adaptation according to uplink or downlink traffic in a robust (such as reliable) manner. For example, full-duplex operations may offer solutions to some dynamic TDD challenges. As such devices may experience higher reliability, high data rates, and greater spectral efficiency as well as lower latency and lower power consumption (in accordance with performing or receiving fewer retransmissions), among other benefits.

Aspects of the disclosure are initially described in the context of wireless communications systems. Aspects of the disclosure are further illustrated by and described with reference to a process flow, apparatus diagrams, system diagrams, and flowcharts that relate to sub-band full-duplex (SBFD) default beam configuration.

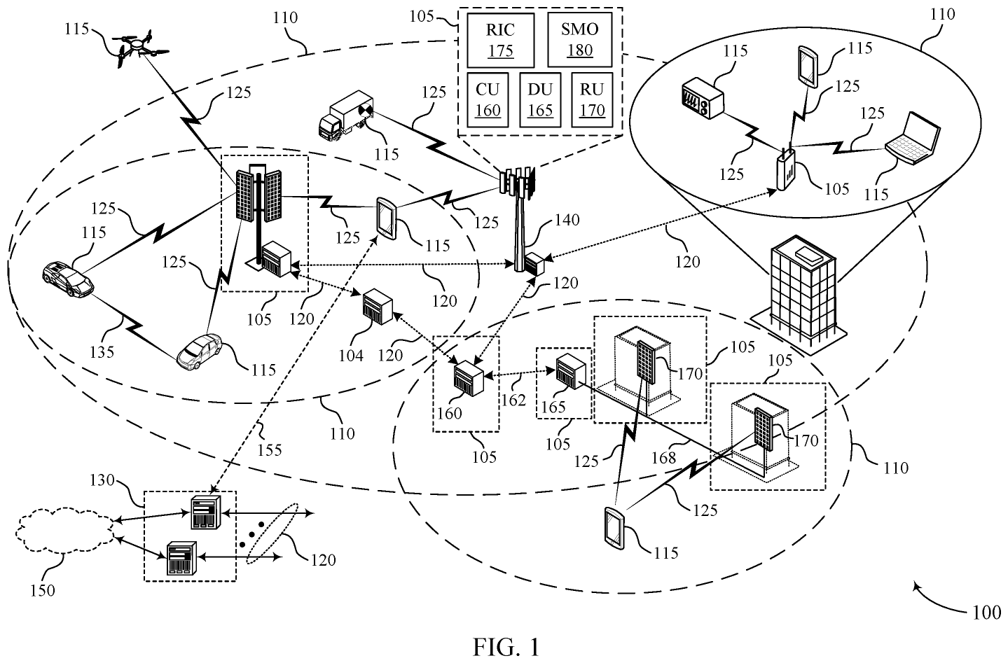

FIG. 1 illustrates an example of a wireless communications system 100 that supports full-duplex default beam configuration in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU—CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support full-duplex default beam configuration as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and TDD component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A quasi co-location (QCL) relationship between one or more transmissions or signals may refer to a relationship between the antenna ports (and the corresponding signaling beams) of the respective transmissions. For example, one or more antenna ports may be implemented by a network entity 105 for transmitting at least one or more reference signals (such as a downlink reference signal, a synchronization signal block (SSB), or the like) and control information transmissions to a UE 115. However, the channel properties of signals sent via the different antenna ports may be interpreted (e.g., by a receiving device) to be the same (e.g., despite the signals being transmitted from different antenna ports), and the antenna ports (and the respective beams) may be described as being quasi co-located (QCLed). QCLed signals may enable the UE 115 to derive the properties of a first signal (e.g., delay spread, Doppler spread, frequency shift, average power) transmitted via a first antenna port from measurements made on a second signal transmitted via a second antenna port. Put another way, if two antenna ports are categorized as being QCLed in terms of, for example, delay spread then the UE 115 may determine the delay spread for one antenna port (e.g., based on a received reference signal, such as CSI-RS) and then apply the result to both antenna ports. Such techniques may avoid the UE 115 determining the delay spread separately for each antenna port. In some cases, two antenna ports may be said to be spatially QCLed, and the properties of a signal sent over a directional beam may be derived from the properties of a different signal over another, different directional beam. That is, QCL relationships may relate to beam information for respective directional beams used for communications of various signals.

Different types of QCL relationships may describe the relationship between two different signals or antenna ports. For instance, QCL-TypeA may refer to a QCL relationship between signals including Doppler shift, Doppler spread, average delay, and delay spread. QCL-TypeB may refer to a QCL relationship including Doppler shift and Doppler spread, whereas QCL-TypeC may refer to a QCL relationship including Doppler shift and average delay. A QCL-TypeD may refer to a QCL relationship of spatial parameters, which may indicate a relationship between two or more directional beams used to communicate signals. Here, the spatial parameters may indicate that a first beam used to transmit a first signal may be similar (or the same) as another beam used to transmit a second, different, signal, or, that the same receive beam may be used to receive both the first and the second signal. Thus, the beam information for various beams may be derived through receiving signals from a transmitting device, where, in some cases, the QCL information or spatial information may help a receiving device efficient identify communications beams (e.g., without having to sweep through a large number of beams to identify the best beam (e.g., the beam having a highest signal quality)). In addition, QCL relationships may exist for both uplink and downlink transmissions and, in some cases, a QCL relationship may also be referred to as spatial relationship information.

In some examples, a transmission configuration indication (TCI) state may include one or more parameters associated with a QCL relationship between transmitted signals. For example, a network entity 105 may configure a QCL relationship that provides a mapping between a reference signal and antenna ports of another signal (e.g., a DMRS antenna port for PDCCH, a DMRS antenna port for PDSCH, a CSI-RS antenna port for CSI-RS, or the like), and the TCI state may be indicated to the UE 115 by the network entity 105. In some cases, a set of TCI states may be indicated to a UE 115 via RRC signaling, where some number of TCI states (e.g., a pool of 8 TCI states from of a total of 64 TCI states) may be configured via RRC and a particular TCI state may be indicated via a MAC-CE or DCI (e.g., within a CORESET). The QCL relationship associated with the TCI state (and further established through higher-layer parameters) may provide the UE 115 with the QCL relationship for respective antenna ports and reference signals transmitted by the network entity 105. In accordance with the techniques described herein, a default beam may be determined based on one or more TCI states, one or more QCL relationships, or any combination thereof. For instance, a network entity 105 may transmit an indication of one or more TCI states, or one or more QCL relationships, or any combination thereof, to indicate a default beam for full-duplex communications (e.g., for use in a full-duplex slot). In some aspects, a default beam may be indicated or determined, or both, based on one or more spatial filtering parameters.

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Various devices within the wireless communications system 100 may support one or more levels of duplex operation, which may depend on or be associated with a deployment scenario, a duplex mode (such as TDD only, FDD only, or both TDD and FDD), performance evaluation results, evaluation methodology, or an interference management procedure. In some aspects, a wireless device (e.g., a UE 115, a network entity 105, or an IAB node 104) within the wireless communications system 100 may support half-duplex or full-duplex operation. For example, a network entity 105 may support various types of MIMO communication, including downlink multi-user MIMO (MU-MIMO) according to which the network entity 105 may transmit downlink signaling to two different UEs 115 simultaneously, uplink MU-MIMO according to which the network entity 105 may receive uplink signaling from two different UEs 115 simultaneously, or downlink and uplink MU-MIMO (which may be referred to herein as full-duplex operation) according to which the network entity 105 may transmit downlink signaling to a first UE 115 while simultaneously receiving uplink signaling from a second UE 115. A network entity 105 may further support enhanced MIMO (eMIMO) or further enhanced MIMO (FeMIMO), which may be associated with an FeMIMO beam management session. In accordance with full-duplex operation, a wireless device may be capable of transmitting and receiving simultaneously. In other words, the wireless device may support simultaneous uplink and downlink transmissions (such as an uplink transmission and a downlink transmission that at least partially overlap in time).

In some aspects, a network entity 105 and a UE 115 may support various evaluation techniques and performance evaluation metrics associated with different deployment scenarios for full-duplex operation (such as for NR duplexing). Further, a network entity 105 and a UE 115 may support one or more techniques to support co-existence with other systems in any co-channels or adjacent channels for sub-band non-overlapping full-duplex operation or for dynamic or flexible TDD, or for both. For example, a network entity 105 and a UE 115 may support techniques associated with duplex operation evolution for NR TDD across various spectrums, including in an unpaired spectrum. In such examples, the network entity 105 may support full-duplex operation (e.g., duplexing enhancement), a UE 115 may support half-duplex operation, and the network entity 105 and the UE 115 may configure or expect no restrictions on which frequency ranges are available for use.

Such techniques may include various full-duplex types or schemes and corresponding metrics to evaluate a performance of such full-duplex types or schemes, inter-network entity (e.g., inter-gNB) and inter-UE CLI mitigation techniques, intra-sub-band CLI and inter-sub-band CLI mitigation techniques (such as in the implementation of sub-band non-overlapping full-duplex), or a metric-based evaluation procedure for an impact of full-duplex operation on half-duplex operation (assuming co-existence in co-channel and adjacent channels). Additionally, or alternatively, such techniques may include a metric-based evaluation procedure for an impact on RF constraints considering adjacent channel co-existence or for an impact on RF constraints considering self-interference, inter-sub-band CLI and inter-operator CLI at network entities 105, and inter-sub-band CLI and inter-operator CLI at UEs 115. Further, such techniques may include antenna or RF and algorithm design for interference mitigation, including antenna isolation, transmission interference management suppression in a receive-side part, filtering, and digital interference suppression. Further, such techniques may comply with one or more regulatory or network specifications associated with full-duplex operation in TDD unpaired spectrums.

Further, some systems may support one or more techniques associated with dynamic or flexible TDD or SBFD, or both, for gNB-gNB CLI handling. Such one or more techniques may include mechanisms related to gNB-to-gNB CLI measurement and reporting, coordinated scheduling, spatial domain designs, receiver designs, UE and network entity transmission and reception timing, power control-based designs, or sensing-based mechanisms, among other example techniques associated with UE-to-UE CLI handling. In some aspects, such one or more techniques may be associated with an identification of whether a scheme or design include over-the-air (OTA) or backhaul information exchanges.

In some deployments, a full-duplex or dynamic TDD-capable device may support a sub-band configuration according to which the device may transmit via a first set of one or more sub-bands and receive via a second set of one or more sub-bands, where the first and second sets of sub-bands may overlap or may be non-overlapping in the frequency domain. In such deployments, devices may also support beamformed communications including the indication of a “default” beam which allows a device such as a UE 115 or a network entity 105 to use a preconfigured or default beam configuration to receive downlink communications in half-duplex scenarios. For example, a device may select a beam with a relatively highest RSRP or signal quality as the default beam.

In such systems, however, one or more wireless communication devices may also support full-duplex or flexible TDD communications schemes, which may be associated with relatively higher levels of self-interference and cross-link interference as compared to some half-duplex deployments, and the selection of a default beam based on RSRP may be unreliable. A wireless communications device such as a network entity 105, therefore, may define a default beam for full-duplex communications using a number of other techniques. For example, a network entity 105 may indicate a downlink or uplink default beam, multiple (e.g., two) default downlink beams or multiple (e.g., two) default uplink beams, or a pair of default and uplink default beams (e.g., one downlink beam paired with one uplink beam) for full-duplex communications in a SBFD slot via control signaling. In some other examples, the default beam may be implicitly determined based on a beam associated with the lowest COREST index in the latest slot of the same slot type.

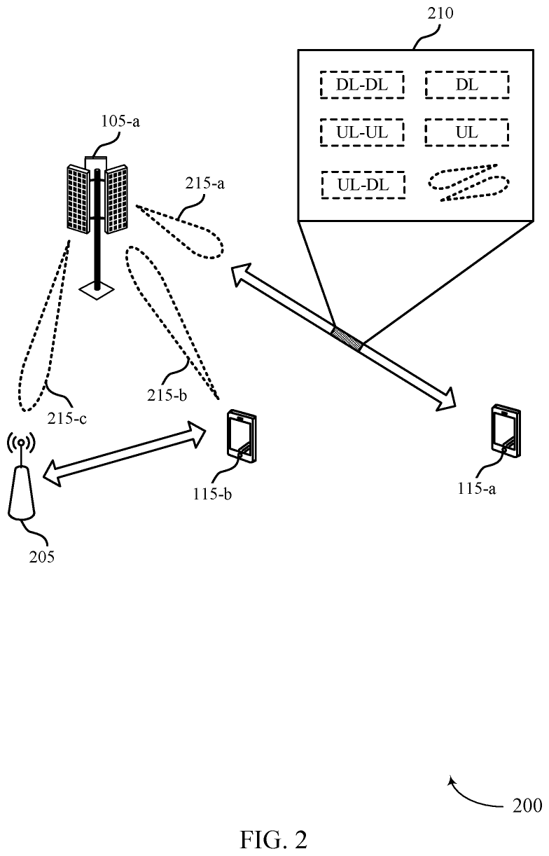

FIG. 2 illustrates an example of a wireless communications system 200 that supports full-duplex default beam configuration in accordance with one or more aspects of the present disclosure. For example, wireless communications system 200 may support communications between one or more UEs (e.g., UE 115-a and UE 115-b) and a network entity 105-a, as well as one or more TRPs (e.g., TRP 205). Each of the UEs may be an example of a UE 115 described with reference to FIG. 1, and the network entity 105-a may be an example of a network entity 105 described with reference to FIG. 1.

Wireless communications system 200 may support beamformed communications between multiple connected devices. For example, a network entity 105-a may communicate with a UE 115-a, a UE 115-b, and one or more of TRPs 205 via uplink and downlink beams. In some implementations, the network entity 105-a may indicate one or more “default” or configured beams (e.g., beam 215-a, beam 215-b, beam 215-c) to reduce beam switch latency and overhead, which allows a device to use a preconfigured or default beam configuration to receive downlink communications or transmit uplink communications. For example, a device chooses a beam with a relatively highest RSRP or signal quality as the default beam in a half-duplex setting. In some such systems, however, one or more wireless communication devices may also support full-duplex or flexible TDD communication, where devices such as the network entity 105-a and the UE 115-a may simultaneously transmit and receive uplink and downlink communications, or may switch between transmitting and receiving uplink and downlink communication across various time intervals. For example, a full-duplex or dynamic TDD capable device may support a sub-band configuration (e.g., SBFD) where the device may simultaneously transmit via a first set of one or more sub-bands and receive via a second set of one or more sub-bands. In some other examples, devices may support fully overlapping full-duplex or partially overlapping full-duplex modes.

In some implementations, a downlink or uplink default beam may be based on a beam corresponding to the lowest CORESET index in a previous slot. For example, a device may select a beam that has a highest RSRP of a set of beams for downlink receptions or uplink transmissions. In full-duplex operations, however, beam configurations may differ for SBFD symbols and non-SBFD symbols, since a previous slot may include both uplink and downlink sub-bands. Additionally, or alternatively, since SBFD symbols may be associated with higher self-interference, higher inter-network entity CLI, and higher inter-UE CLI as compared to downlink or uplink slots, the network entity 105-a may configure a different downlink or uplink beams for SBFD slots that may be based on a beam having a highest RSRP or may not be based on a beam having a highest RSRP.

To support efficient communications and to reduce beam-switch latency for beamformed communications, the network entity 105-a may indicate a default beam for full-duplex deployments, including a configuration for an uplink default beam. For example, the network entity 105-a may indicate (e.g., via an explicit indication 210) one or more default downlink beams, one or more default uplink beams that may be used for SBFD operations. For example, the network entity 105-a may indicate a single uplink default beam, a single downlink default beam, two default downlink beams, two uplink default beams, or a pair of default and uplink default beams (e.g., one downlink beam paired with one uplink beam) for full-duplex communications in a SBFD slot. For example, the network entity 105-a may indicate two uplink default beams or two default downlink beams to support multi-TRP operations (e.g., communications from multiple TRPs including TRP 205) or for communications with multiple UEs (e.g., UE 115-a and UE 115-b) in a SBFD slot. In some examples, this indication may be conveyed via control signaling (e.g., via an RRC message, a medium access control-control element (MAC-CE), or a downlink control information (DCI) message, or any combination thereof). In some aspects, the network device or a UE may be able to implicitly determine the default beam based on a beam associated with the lowest CORESET index in the latest slot of the same slot type. For example, a UE 115 may determine the default beam for a SBFD slot based on a beam associated with the relatively lowest CORESET index in the most recent SBFD slot (e.g., default beams may be determined based on the CORESET index of a preceding slot of the same type). Conversely, to determine the default beam for a downlink slot, the UE 115 would determine the beam associated with the lowest CORESET index in the most recent downlink slot.

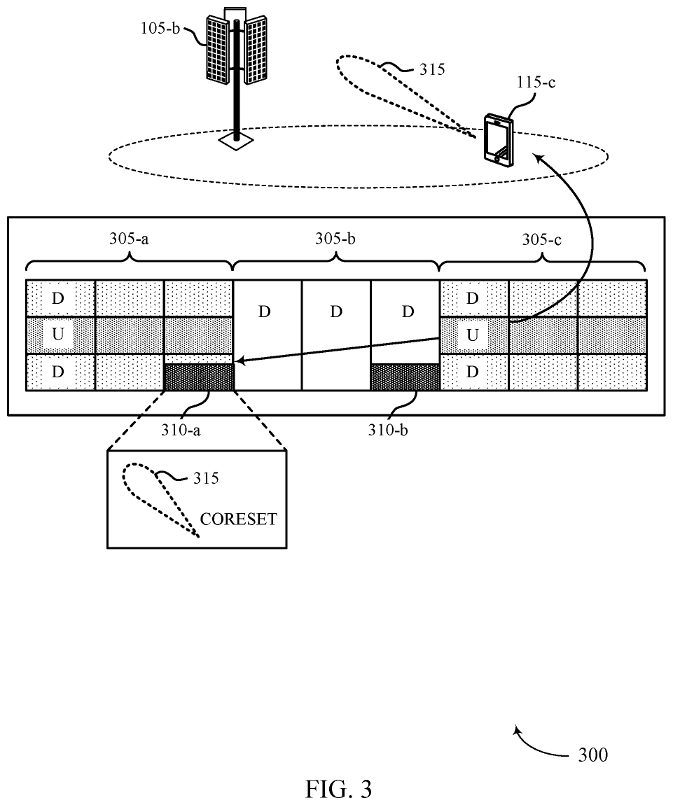

FIG. 3 illustrates an example of a wireless communications system 300 that supports full-duplex default beam configuration in accordance with one or more aspects of the present disclosure. For example, wireless communications system 300 may support communications between a UE 115-c and a network entity 105-b, each of which may be examples of corresponding devices described with reference to FIGS. 1 and 2.

A network entity 105-b may communicate with a UE 115-c via uplink and downlink beams. For example, the UE 115-c may determine one or more uplink or downlink default beams to use to reduce beam switch latency and overhead. In some implementations, the UE 115-c may determine an uplink or downlink default beam based on a beam associated with a lowest CORESET index in the latest slot of the same slot type (e.g., SBFD slot, uplink slot, downlink slot). For example, the UE 115-c may determine the default uplink beam 315 for the SBFD slot 305-c based on the beam associated with the lowest CORESET index 310-a in the last SBFD slot 305-a (e.g., rather than the lowest CORESET index 310-b in the last downlink slot 305-b). Additionally, or alternatively, the UE 115-c may determine a default beam for a next downlink slot based on the beam associated with the lowest CORESET index 310-b in the last downlink slot 305-b. In such examples, the default uplink or downlink beam may be different per-slot type (e.g., the uplink or downlink beam may be different based on whether the slot type is an SBFD slot or a non-SBFD slot).

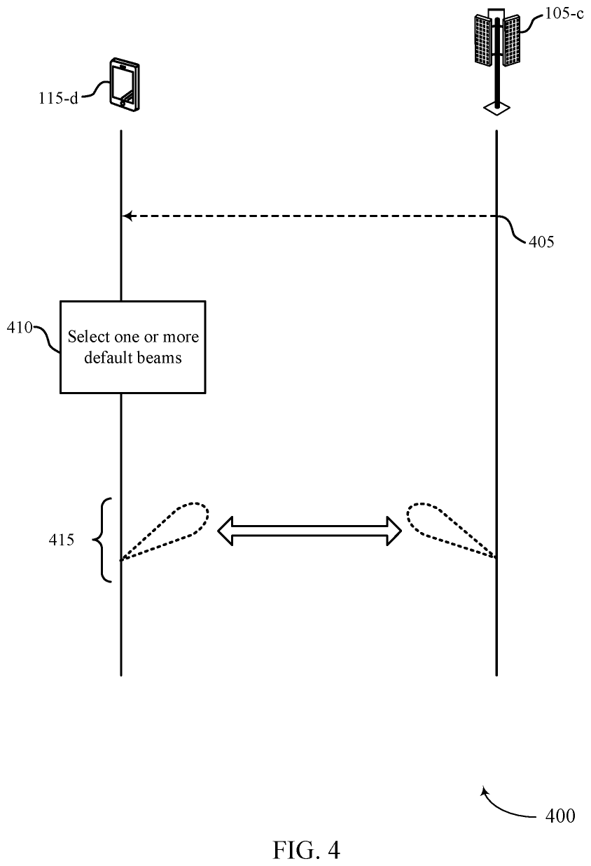

FIG. 4 illustrates an example of a process flow 400 that supports full-duplex default beam configuration in accordance with one or more aspects of the present disclosure. The process flow 400 may implement or may be implemented to realize or facilitate aspects of the wireless communications system 100, 200, or 300. For example, the process flow 400 illustrates communication between a UE 115-d, and a network entity 105-c. The UE 115-d and the network entity 105-c as illustrated by and described with reference to FIG. 4 may be examples of corresponding devices illustrated and described herein, including with reference to FIGS. 1-3. In some examples, the network entity 105-c may support a dynamic TDD communication scheme or a full-duplex communication scheme, such as a SBFD communication scheme.

In the following description of the process flow 400, the operations may be performed (such as reported or provided) in a different order than the order shown, or the operations performed by the example devices may be performed in different orders or at different times. Some operations also may be left out of the process flow 400, or other operations may be added to the process flow 400. Further, although some operations or signaling may be shown to occur at different times for discussion purposes, these operations may actually occur at the same time.

At 405, the network entity 105-c may transmit a control message (e.g., via RRC. MAC-CE, DCI) indicating a first set of one or more default beams for full-duplex communications (e.g., full duplex communications at the network entity 105-c), the first set of one or more default beams being configured for communications with the UE 115-d during one or more full-duplex symbol periods. The full duplex communications may include SBFD communications, fully overlapping full-duplex communications, partial overlapping full-duplex communications, or any combination thereof.

At 410, the UE 115-d may select a first set of one or more default beams for full-duplex communications, the first set of one or more default beams being configured for communications with one or more TRPs associated with the network entity 105-c during the one or more full-duplex symbol periods. In some examples, the first set of one or more default beams include two or more default uplink beams or two or more default downlink beams, each default uplink beam or default downlink beam of the two or more default uplink beams or downlink beams being associated with a respective TRP at least two TRPs. In some examples, the first set of one or more default beams include a default beam pair including one uplink default beam and one downlink default beam configured for full-duplex communications performed by the network entity 105-c. In some examples, the first set of one or more default beams is different from a second set of one or more default beams used for communicating with the one or more TRPs during respective symbol periods configured for TDD uplink communications or downlink communications.

In some examples, the UE 115-d may select the first set of one or more default beams by determining a lowest CORESET index value in a latest slot that precedes the one or more full-duplex symbol periods, uplink symbol periods, downlink symbol periods, or flexible symbol periods. In such examples, the latest slot and the one or more full-duplex symbol periods, uplink symbol periods, downlink symbol periods, or flexible symbol periods may be of the same slot type, and the UE 115-d may identify the first set of one or more default beams based on a beam that is associated with a lowest CORESET index value.

At 415, the UE 115-d may communicate with the network entity 105-c via the one or more TRPs using the first set of one or more default beams during at least one symbol period of the one or more full-duplex symbol periods. In some examples, the UE 115-d may communicate with the network entity 105-c via a first TRP using one default uplink beam or one default downlink beam associated with the first TRP.

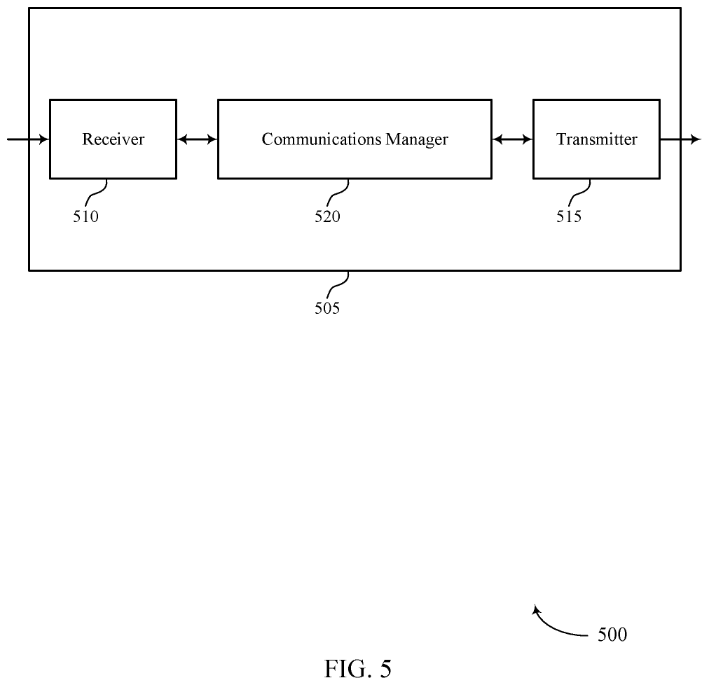

FIG. 5 illustrates a block diagram 500 of a device 505 that supports full-duplex default beam configuration in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to full-duplex default beam configuration). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to full-duplex default beam configuration). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of full-duplex default beam configuration as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication in accordance with examples as disclosed herein. For example, the communications manager 520 may be configured as or otherwise support a means for selecting a first set of one or more default beams for full-duplex communications, the first set of one or more default beams being configured for communications with one or more TRPs during one or more full-duplex symbol periods. The communications manager 520 may be configured as or otherwise support a means for communicating with the one or more TRPs using the first set of one or more default beams during at least one symbol period of the one or more full-duplex symbol periods.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, more efficient utilization of communication resources.

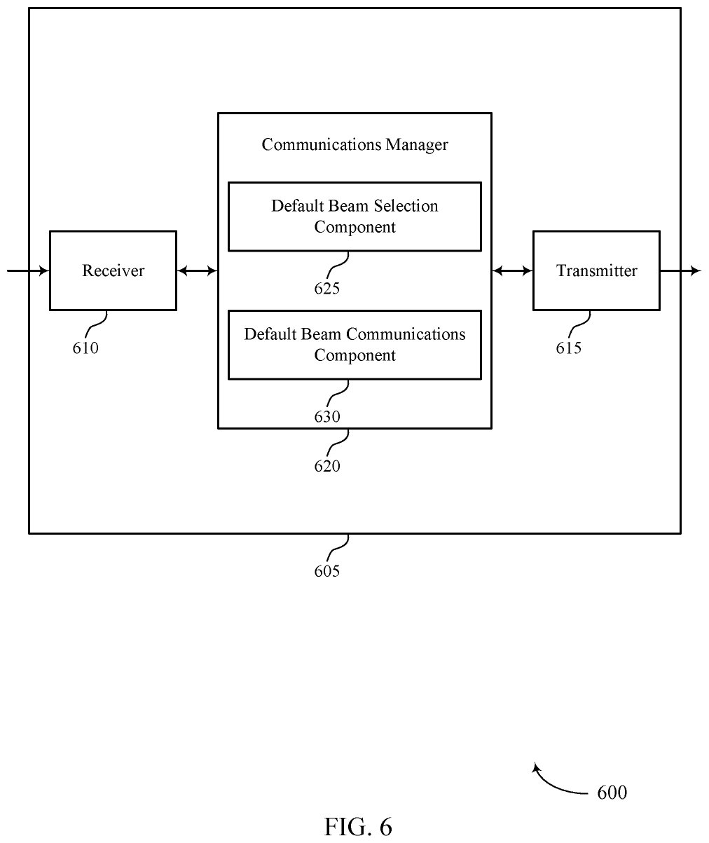

FIG. 6 illustrates a block diagram 600 of a device 605 that supports full-duplex default beam configuration in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to full-duplex default beam configuration). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to full-duplex default beam configuration). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of full-duplex default beam configuration as described herein. For example, the communications manager 620 may include a default beam selection component 625 a default beam communications component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. The default beam selection component 625 may be configured as or otherwise support a means for selecting a first set of one or more default beams for full-duplex communications, the first set of one or more default beams being configured for communications with one or more TRPs during one or more full-duplex symbol periods. The default beam communications component 630 may be configured as or otherwise support a means for communicating with the one or more TRPs using the first set of one or more default beams during at least one symbol period of the one or more full-duplex symbol periods.

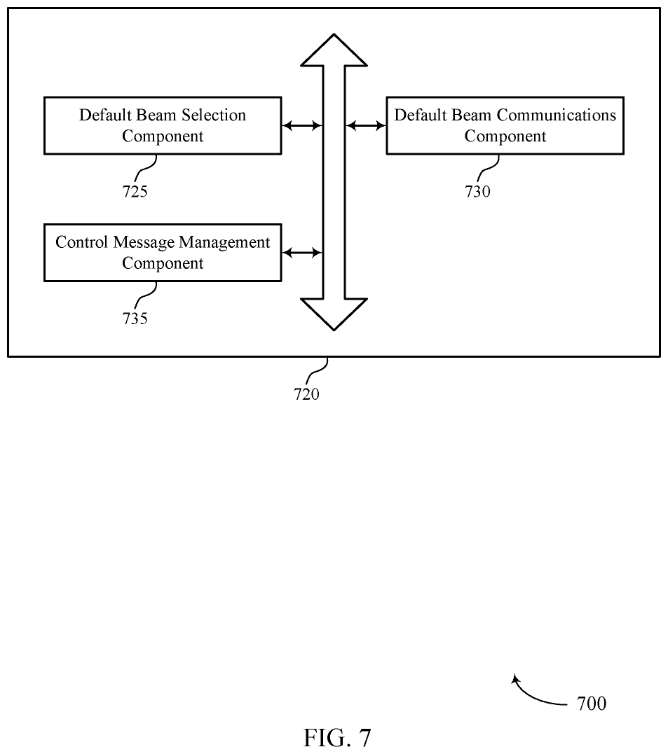

FIG. 7 illustrates a block diagram 700 of a communications manager 720 that supports full-duplex default beam configuration in accordance with one or more aspects of the present disclosure. The communications manager 720 may be an example of aspects of a communications manager 520, a communications manager 620, or both, as described herein. The communications manager 720, or various components thereof, may be an example of means for performing various aspects of full-duplex default beam configuration as described herein. For example, the communications manager 720 may include a default beam selection component 725, a default beam communications component 730, a control message management component 735, or any combination thereof. Each of these components may communicate, directly or indirectly, with one another (e.g., via one or more buses).

The communications manager 720 may support wireless communication in accordance with examples as disclosed herein. The default beam selection component 725 may be configured as or otherwise support a means for selecting a first set of one or more default beams for full-duplex communications, the first set of one or more default beams being configured for communications with one or more TRPs during one or more full-duplex symbol periods. The default beam communications component 730 may be configured as or otherwise support a means for communicating with the one or more TRPs using the first set of one or more default beams during at least one symbol period of the one or more full-duplex symbol periods.

In some examples, to support communicating with the one or more TRPs, the default beam communications component 730 may be configured as or otherwise support a means for communicating with at least two TRPs of the one or more TRPs, where the first set of one or more default beams includes two or more default uplink beams, each default uplink beam of the two or more default uplink beams being associated with a respective TRP of the at least two TRPs.

In some examples, to support communicating with the one or more TRPs, the default beam communications component 730 may be configured as or otherwise support a means for communicating with at least two TRPs of the one or more TRPs, where the first set of one or more default beams includes two or more default downlink beams, each default downlink beam of the two or more default downlink beams being associated with a respective TRP of the at least two TRPs.

In some examples, to support communicating with the one or more TRPs, the default beam communications component 730 may be configured as or otherwise support a means for communicating with a first TRP of the one or more TRPs, where the first set of one or more default beams includes one default uplink beam associated with the first TRP or one default downlink beam associated with the first TRP.

In some examples, the first set of one or more default beams includes a default beam pair, the default beam pair including one default uplink beam and one default downlink beam.

In some examples, the default beam pair including the one default uplink beam and the one default downlink beam is configured for the full-duplex communications with at least one TRP of the one or more TRPs during the one or more full-duplex symbol periods.

In some examples, the control message management component 735 may be configured as or otherwise support a means for receiving a control message indicating the first set of one or more default beams, where the first set of one or more default beams are identified based on receiving the control message.

In some examples, the control message includes an RRC message, a MAC-CE, DCI, or any combination thereof.

In some examples, the default beam selection component 725 may be configured as or otherwise support a means for determining a lowest CORESET index value in a latest slot that precedes the one or more full-duplex symbol periods based on the latest slot and the one or more full-duplex symbol periods both being configured for the full-duplex communications, where the first set of one or more default beams is identified based on a beam that is associated with a lowest CORESET index value.

In some examples, the first set of one or more default beams is different from a second set of one or more default beams used for communicating with the one or more TRPs during respective symbol periods configured for time-division duplexed uplink communications or downlink communications.

In some examples, the default beam selection component 725 may be configured as or otherwise support a means for determining a lowest CORESET index value in a latest slot that precedes an uplink symbol period, a downlink symbol period, or a flexible symbol period based on the latest slot and the uplink symbol period, the downlink symbol period, or the flexible symbol period both being configured for time-division duplexed communications, where a second set of one or more default beams is identified based on a beam that is associated with a lowest CORESET index value.

In some examples, the full-duplex communications are performed at a network entity during the one or more full-duplex symbol periods.

In some examples, the full-duplex communications include sub-band full duplex communications, fully overlapping full-duplex communications, partial overlapping full-duplex communications, or any combination thereof.

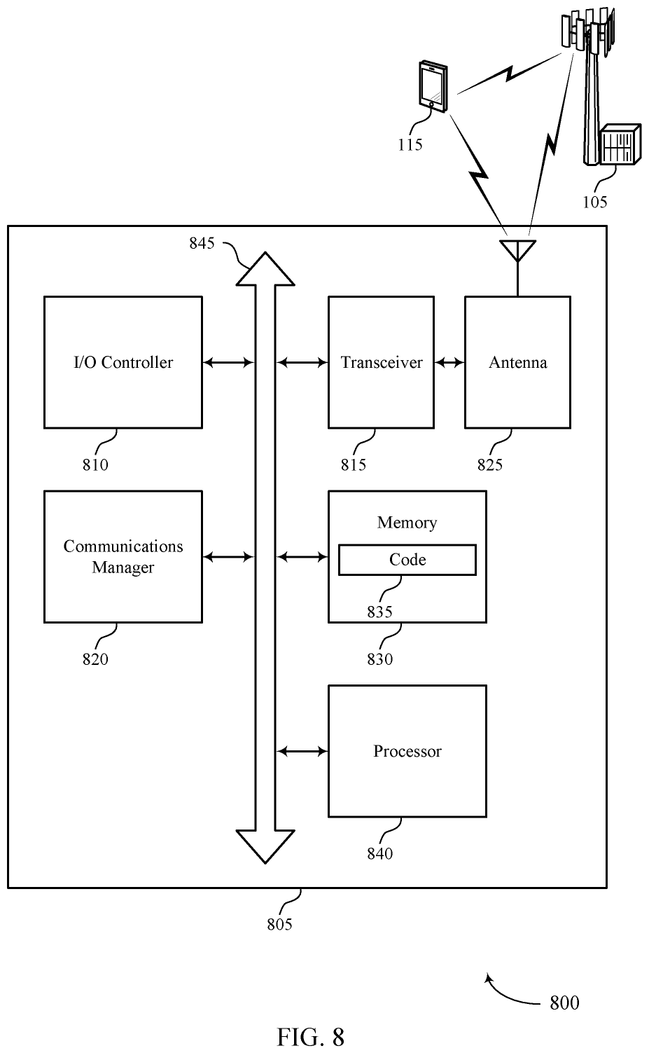

FIG. 8 illustrates a diagram of a system 800 including a device 805 that supports full-duplex default beam configuration in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting full-duplex default beam configuration). For example, the device 805 or a component of the device 805 may include a processor 840 and memory 830 coupled with or to the processor 840, the processor 840 and memory 830 configured to perform various functions described herein.

The communications manager 820 may support wireless communication in accordance with examples as disclosed herein. For example, the communications manager 820 may be configured as or otherwise support a means for selecting a first set of one or more default beams for full-duplex communications, the first set of one or more default beams being configured for communications with one or more TRPs during one or more full-duplex symbol periods. The communications manager 820 may be configured as or otherwise support a means for communicating with the one or more TRPs using the first set of one or more default beams during at least one symbol period of the one or more full-duplex symbol periods.

By including or configuring the communications manager 820 in accordance with examples as described herein, the device 805 may support techniques for improved communication reliability, reduced latency, more efficient utilization of communication resources, improved coordination between devices, increased system capacity, resource utilization, and spectrum efficiency, flexible and dynamic uplink or downlink resource adaptation according to uplink or downlink traffic, higher reliability, high data rates, and greater spectral efficiency as well as lower latency and lower power consumption (in accordance with performing or receiving fewer retransmissions), among other benefits.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of full-duplex default beam configuration as described herein, or the processor 840 and the memory 830 may be otherwise configured to perform or support such operations.

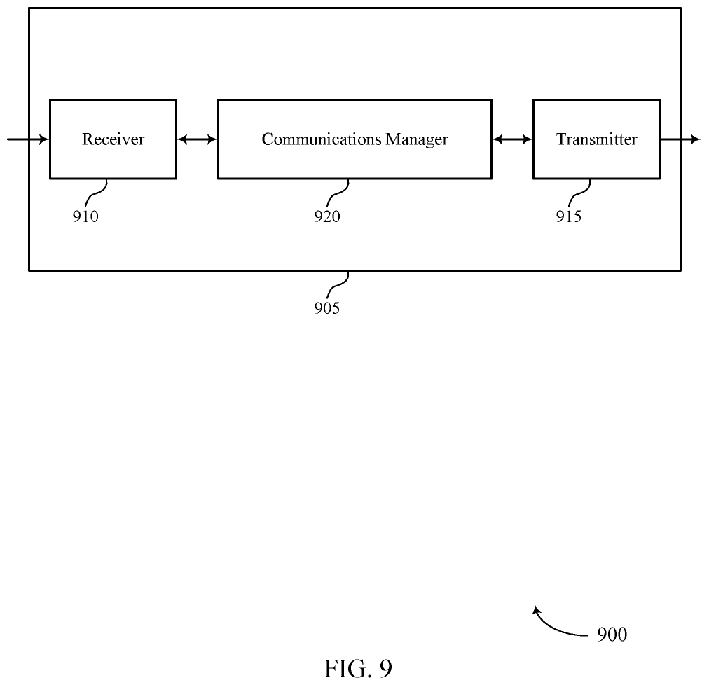

FIG. 9 illustrates a block diagram 900 of a device 905 that supports full-duplex default beam configuration in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of full-duplex default beam configuration as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication in accordance with examples as disclosed herein. For example, the communications manager 920 may be configured as or otherwise support a means for transmitting a control message indicating a first set of one or more default beams for full-duplex communications, the first set of one or more default beams being configured for communications with a UE during one or more full-duplex symbol periods. The communications manager 920 may be configured as or otherwise support a means for communicating with the UE using the first set of one or more default beams during at least one symbol period of the one or more full-duplex symbol periods.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing, reduced power consumption, more efficient utilization of communication resources.

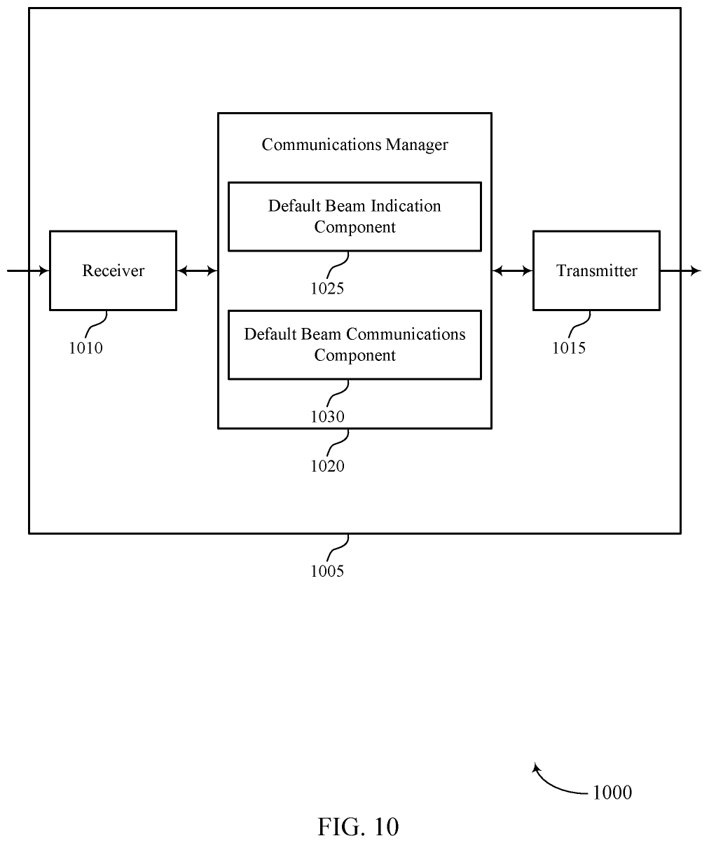

FIG. 10 illustrates a block diagram 1000 of a device 1005 that supports full-duplex default beam configuration in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of full-duplex default beam configuration as described herein. For example, the communications manager 1020 may include a default beam indication component 1025 a default beam communications component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication in accordance with examples as disclosed herein. The default beam indication component 1025 may be configured as or otherwise support a means for transmitting a control message indicating a first set of one or more default beams for full-duplex communications, the first set of one or more default beams being configured for communications with a UE during one or more full-duplex symbol periods. The default beam communications component 1030 may be configured as or otherwise support a means for communicating with the UE using the first set of one or more default beams during at least one symbol period of the one or more full-duplex symbol periods.

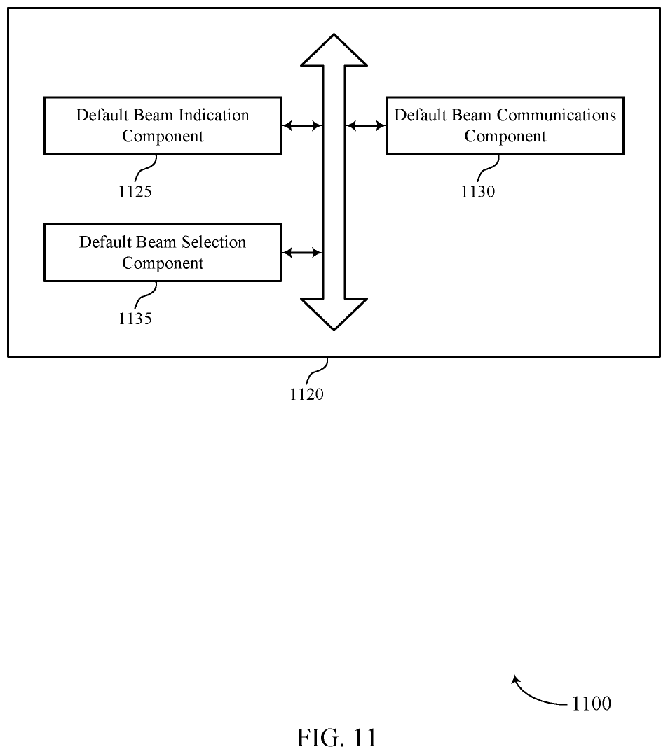

FIG. 11 illustrates a block diagram 1100 of a communications manager 1120 that supports full-duplex default beam configuration in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of full-duplex default beam configuration as described herein. For example, the communications manager 1120 may include a default beam indication component 1125, a default beam communications component 1130, a default beam selection component 1135, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication in accordance with examples as disclosed herein. The default beam indication component 1125 may be configured as or otherwise support a means for transmitting a control message indicating a first set of one or more default beams for full-duplex communications, the first set of one or more default beams being configured for communications with a UE during one or more full-duplex symbol periods. The default beam communications component 1130 may be configured as or otherwise support a means for communicating with the UE using the first set of one or more default beams during at least one symbol period of the one or more full-duplex symbol periods.

In some examples, the first set of one or more default beams includes one or more default downlink beams or one or more default uplink beams, each default downlink beam of the one or more default downlink beams or each default uplink beam of the one or more default uplink beams being associated with a respective TRP.

In some examples, the first set of one or more default beams includes a default beam pair, the default beam pair including one default uplink beam and one default downlink beam. In some examples, the default beam pair including the one default uplink beam and the one default downlink beam is configured for the full-duplex communications with at least one TRP during the at least one symbol period.

In some examples, the control message includes an RRC message, a MAC-CE, DCI, or any combination thereof.

In some examples, the default beam selection component 1135 may be configured as or otherwise support a means for determining a lowest CORESET index value in a latest slot that precedes the one or more full-duplex symbol periods based on the latest slot and the one or more full-duplex symbol periods both being configured for the full-duplex communications, where the first set of one or more default beams is identified based on a beam that is associated with a lowest CORESET index value.

In some examples, the default beam selection component 1135 may be configured as or otherwise support a means for determining a lowest CORESET index value in a latest slot that precedes an uplink symbol period, a downlink symbol period, or a flexible symbol period based on the latest slot and the uplink symbol period, the downlink symbol period, or the flexible symbol period both being configured for time-division duplexed communications, where a second set of one or more default beams is identified based on a beam that is associated with a lowest CORESET index value.

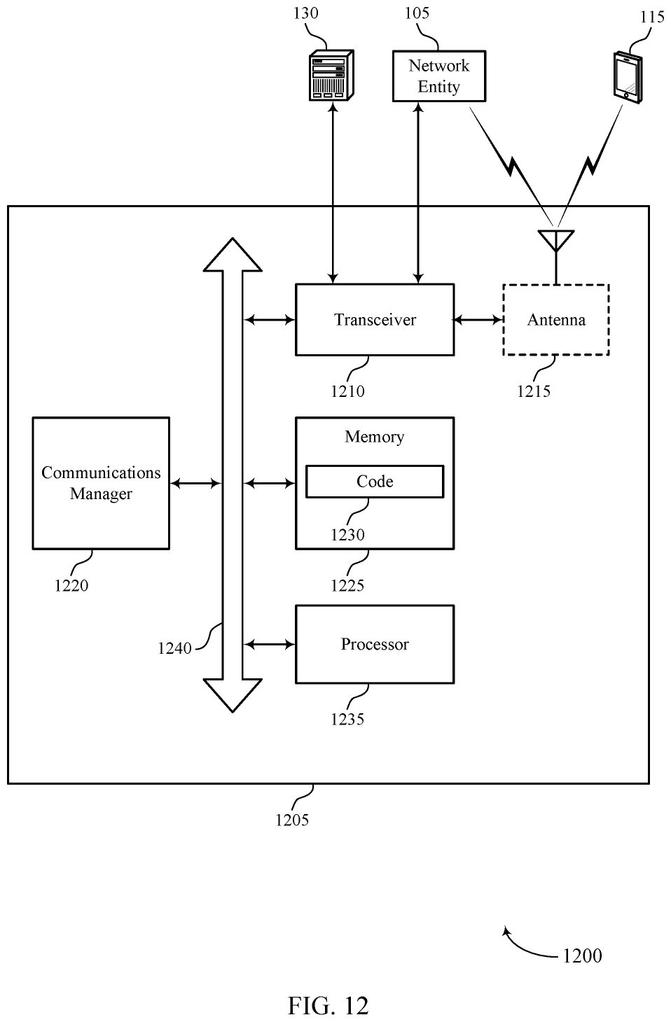

FIG. 12 illustrates a diagram of a system 1200 including a device 1205 that supports full-duplex default beam configuration in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting full-duplex default beam configuration). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication in accordance with examples as disclosed herein. For example, the communications manager 1220 may be configured as or otherwise support a means for transmitting a control message indicating a first set of one or more default beams for full-duplex communications, the first set of one or more default beams being configured for communications with a UE during one or more full-duplex symbol periods. The communications manager 1220 may be configured as or otherwise support a means for communicating with the UE using the first set of one or more default beams during at least one symbol period of the one or more full-duplex symbol periods.

By including or configuring the communications manager 1220 in accordance with examples as described herein, the device 1205 may support techniques for improved communication reliability, reduced latency, more efficient utilization of communication resources, improved coordination between devices, increased system capacity, resource utilization, and spectrum efficiency, flexible and dynamic uplink or downlink resource adaptation according to uplink or downlink traffic, higher reliability, high data rates, and greater spectral efficiency as well as lower latency and lower power consumption (in accordance with performing or receiving fewer retransmissions), among other benefits.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of full-duplex default beam configuration as described herein, or the processor 1235 and the memory 1225 may be otherwise configured to perform or support such operations.

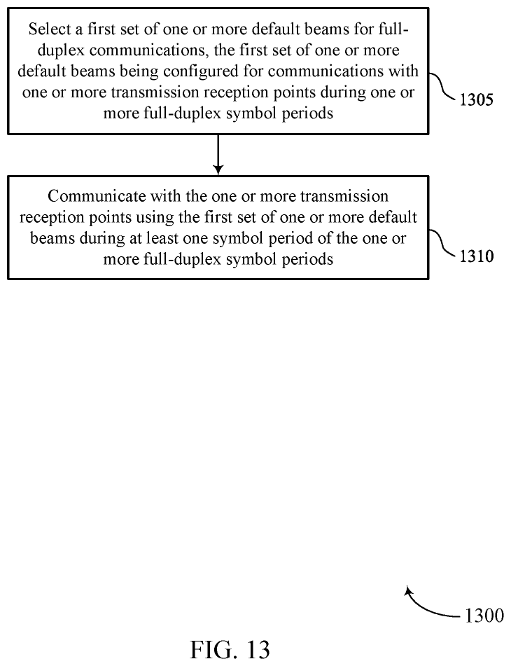

FIG. 13 illustrates a flowchart showing a method 1300 that supports full-duplex default beam configuration in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include selecting a first set of one or more default beams for full-duplex communications, the first set of one or more default beams being configured for communications with one or more TRPs during one or more full-duplex symbol periods. The operations of 1305 may be performed in accordance with examples as disclosed herein. In some examples, aspects of the operations of 1305 may be performed by a default beam selection component 725 as described with reference to FIG. 7.

At 1310, the method may include communicating with the one or more TRPs using the first set of one or more default beams during at least one symbol period of the one or more full-duplex symbol periods. The operations of 1310 may be performed in accordance with examples as disclosed herein. In some examples, aspects of the operations of 1310 may be performed by a default beam communications component 730 as described with reference to FIG. 7.

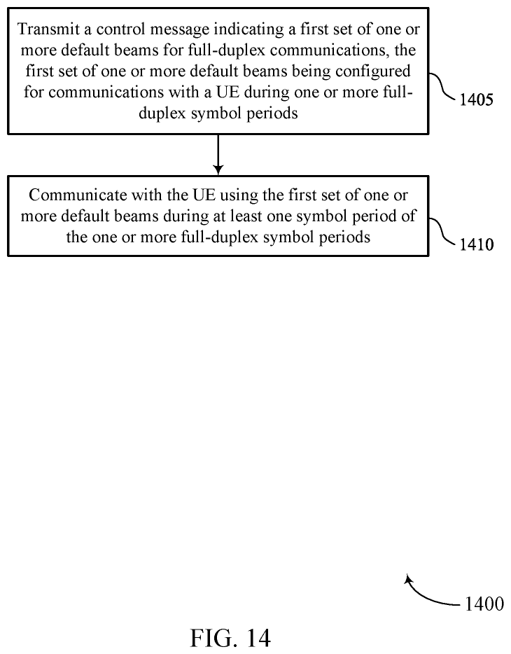

FIG. 14 illustrates a flowchart showing a method 1400 that supports full-duplex default beam configuration in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting a control message indicating a first set of one or more default beams for full-duplex communications, the first set of one or more default beams being configured for communications with a UE during one or more full-duplex symbol periods. The operations of 1405 may be performed in accordance with examples as disclosed herein. In some examples, aspects of the operations of 1405 may be performed by a default beam indication component 1125 as described with reference to FIG. 11.

At 1410, the method may include communicating with the UE using the first set of one or more default beams during at least one symbol period of the one or more full-duplex symbol periods. The operations of 1410 may be performed in accordance with examples as disclosed herein. In some examples, aspects of the operations of 1410 may be performed by a default beam communications component 1130 as described with reference to FIG. 11.

The following provides an overview of aspects of the present disclosure:
Aspect 1: A method for wireless communication, comprising: selecting a first set of one or more default beams for full-duplex communications, the first set of one or more default beams being configured for communications with one or more TRPs during one or more full-duplex symbol periods; and communicating with the one or more TRPs using the first set of one or more default beams during at least one symbol period of the one or more full-duplex symbol periods.
Aspect 2: The method of aspect 1, wherein communicating with the one or more TRPs comprises: communicating with at least two TRPs of the one or more TRPs, wherein the first set of one or more default beams comprises two or more default uplink beams, each default uplink beam of the two or more default uplink beams being associated with a respective TRP of the at least two TRPs.
Aspect 3: The method of aspect 2, wherein communicating with the one or more TRPs comprises: communicating with at least two TRPs of the one or more TRPs, wherein the first set of one or more default beams comprises two or more default downlink beams, each default uplink beam of the two or more default downlink beams being associated with a respective TRP of the at least two TRPs.
Aspect 4: The method of any of aspects 1 through 3, wherein communicating with the one or more TRPs comprises: communicating with a first TRP of the one or more TRPs, wherein the first set of one or more default beams comprises one default uplink beam associated with the first TRP or one default downlink beam associated with the first TRP.
Aspect 5: The method of any of aspects 1 through 4, wherein the first set of one or more default beams comprises a default beam pair, the default beam pair comprising one default uplink beam and one default downlink beam.
Aspect 6: The method of aspect 5, wherein the default beam pair comprising the one default uplink beam and the one default downlink beam is configured for the full-duplex communications with at least one TRP of the one or more TRPs during the one or more full-duplex symbol periods.
Aspect 7: The method of any of aspects 1 through 6, further comprising: receiving a control message indicating the first set of one or more default beams, wherein the first set of one or more default beams are identified based at least in part on receiving the control message.
Aspect 8: The method of aspect 7, wherein the control message comprises a RRC message, a MAC-CE, DCI, or any combination thereof.
Aspect 9: The method of any of aspects 1 through 8, further comprising: determining a lowest CORESET index value in a latest slot that precedes the one or more full-duplex symbol periods based at least in part on the latest slot and the one or more full-duplex symbol periods both being configured for the full-duplex communications, wherein the first set of one or more default beams is identified based at least in part on a beam that is associated with a lowest CORESET index value.
Aspect 10: The method of any of aspects 1 through 9, wherein the first set of one or more default beams is different from a second set of one or more default beams used for communicating with the one or more TRPs during respective symbol periods configured for TDD uplink communications or downlink communications.
Aspect 11: The method of any of aspects 1 through 10, further comprising: determining a lowest CORESET index value in a latest slot that precedes an uplink symbol period, a downlink symbol period, or a flexible symbol period based at least in part on the latest slot and the uplink symbol period, the downlink symbol period, or the flexible symbol period both being configured for TDD communications, wherein a second set of one or more default beams is identified based at least in part on a beam that is associated with a lowest CORESET index value.
Aspect 12: The method of any of aspects 1 through 11, wherein the full-duplex communications are performed at a network entity during the one or more full-duplex symbol periods.
Aspect 13: The method of any of aspects 1 through 12, wherein the full-duplex communications comprise SBFD communications, fully overlapping full-duplex communications, partial overlapping full-duplex communications, or any combination thereof.
Aspect 14: A method for wireless communication, comprising: transmitting a control message indicating a first set of one or more default beams for full-duplex communications, the first set of one or more default beams being configured for communications with a UE during one or more full-duplex symbol periods; and communicating with the UE using the first set of one or more default beams during at least one symbol period of the one or more full-duplex symbol periods.
Aspect 15: The method of aspect 14, wherein the first set of one or more default beams comprises one or more default downlink beams or one or more default uplink beams, each default downlink beam of the one or more default downlink beams or each default uplink beam of the one or more default uplink beams being associated with a respective TRP.
Aspect 16: The method of any of aspects 14 through 15, wherein the first set of one or more default beams comprises a default beam pair, the default beam pair comprising one default uplink beam and one default downlink beam, the default beam pair comprising the one default uplink beam and the one default downlink beam is configured for the full-duplex communications with at least one TRP during the at least one symbol period.
Aspect 17: The method of any of aspects 14 through 16, wherein the control message comprises an RRC message, a MAC-CE, DCI, or any combination thereof.
Aspect 18: The method of any of aspects 14 through 17, further comprising: determining a lowest CORESET index value in a latest slot that precedes the one or more full-duplex symbol periods based at least in part on the latest slot and the one or more full-duplex symbol periods both being configured for the full-duplex communications, wherein the first set of one or more default beams is identified based at least in part on a beam that is associated with a lowest CORESET index value.
Aspect 19: The method of any of aspects 14 through 18, further comprising: determining a lowest CORESET index value in a latest slot that precedes an uplink symbol period, a downlink symbol period, or a flexible symbol period based at least in part on the latest slot and the uplink symbol period, the downlink symbol period, or the flexible symbol period both being configured for TDD communications, wherein a second set of one or more default beams is identified based at least in part on a beam that is associated with a lowest CORESET index value.
Aspect 20: An apparatus for wireless communication, comprising a processor; memory coupled with the processor; and instructions stored in the memory and executable by the processor to cause the apparatus to perform a method of any of aspects 1 through 13.
Aspect 21: An apparatus for wireless communication, comprising at least one means for performing a method of any of aspects 1 through 13.
Aspect 22: A non-transitory computer-readable medium storing code for wireless communication, the code comprising instructions executable by a processor to perform a method of any of aspects 1 through 13.
Aspect 23: An apparatus for wireless communication, comprising a processor; memory coupled with the processor; and instructions stored in the memory and executable by the processor to cause the apparatus to perform a method of any of aspects 14 through 19.
Aspect 24: An apparatus for wireless communication, comprising at least one means for performing a method of any of aspects 14 through 19.
Aspect 25: A non-transitory computer-readable medium storing code for wireless communication, the code comprising instructions executable by a processor to perform a method of any of aspects 14 through 19.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
a processor;
memory coupled with the processor; and
instructions stored in the memory and executable by the processor to cause the apparatus to:
select a first set of one or more default beams for full-duplex communications, the first set of one or more default beams being configured for communications with one or more transmission reception points during one or more full-duplex symbol periods; and
communicate with the one or more transmission reception points using the first set of one or more default beams during at least one symbol period of the one or more full-duplex symbol periods.

2. The apparatus of claim 1, wherein the instructions to communicate with the one or more transmission reception points are executable by the processor to cause the apparatus to:
communicate with at least two transmission reception points of the one or more transmission reception points, wherein the first set of one or more default beams comprises two or more default uplink beams, each default uplink beam of the two or more default uplink beams being associated with a respective transmission reception point of the at least two transmission reception points.

3. The apparatus of claim 2, wherein the instructions to communicate with the one or more transmission reception points are executable by the processor to cause the apparatus to:
communicate with at least two transmission reception points of the one or more transmission reception points, wherein the first set of one or more default beams comprises two or more default downlink beams, each default downlink beam of the two or more default downlink beams being associated with a respective transmission reception point of the at least two transmission reception points.

4. The apparatus of claim 1, wherein the instructions to communicate with the one or more transmission reception points are executable by the processor to cause the apparatus to:
communicate with a first transmission reception point of the one or more transmission reception points, wherein the first set of one or more default beams comprises one default uplink beam associated with the first transmission reception point or one default downlink beam associated with the first transmission reception point.

5. The apparatus of claim 1, wherein the first set of one or more default beams comprises a default beam pair, the default beam pair comprising one default uplink beam and one default downlink beam.

6. The apparatus of claim 5, wherein the default beam pair comprising the one default uplink beam and the one default downlink beam is configured for the full-duplex communications with at least one transmission reception point of the one or more transmission reception points during the one or more full-duplex symbol periods.

7. The apparatus of claim 1, wherein the instructions are further executable by the processor to cause the apparatus to:
receive a control message indicating the first set of one or more default beams, wherein the first set of one or more default beams are identified based at least in part on receiving the control message.

8. The apparatus of claim 7, wherein the control message comprises a radio resource control message, a medium access control-control element, downlink control information, or any combination thereof.

9. The apparatus of claim 1, wherein the instructions are further executable by the processor to cause the apparatus to:
determine a lowest control resource set index value in a latest slot that precedes the one or more full-duplex symbol periods based at least in part on the latest slot and the one or more full-duplex symbol periods both being configured for the full-duplex communications, wherein the first set of one or more default beams is identified based at least in part on a beam that is associated with a lowest control resource set index value.

10. The apparatus of claim 1, wherein the first set of one or more default beams is different from a second set of one or more default beams used for communicating with the one or more transmission reception points during respective symbol periods configured for time-division duplexed uplink communications or downlink communications.

11. The apparatus of claim 1, wherein the instructions are further executable by the processor to cause the apparatus to:
determine a lowest control resource set index value in a latest slot that precedes an uplink symbol period, a downlink symbol period, or a flexible symbol period based at least in part on the latest slot and the uplink symbol period, the downlink symbol period, or the flexible symbol period both being configured for time-division duplexed communications, wherein a second set of one or more default beams is identified based at least in part on a beam that is associated with a lowest control resource set index value.

12. The apparatus of claim 1, wherein the full-duplex communications are performed at a network entity during the one or more full-duplex symbol periods.

13. The apparatus of claim 1, wherein the full-duplex communications comprise sub-band full duplex communications, fully overlapping full-duplex communications, partial overlapping full-duplex communications, or any combination thereof.

14. An apparatus for wireless communication, comprising:
a processor;
memory coupled with the processor; and
instructions stored in the memory and executable by the processor to cause the apparatus to:
transmit a control message indicating a first set of one or more default beams for full-duplex communications, the first set of one or more default beams being configured for communications with a user equipment (UE) during one or more full-duplex symbol periods; and
communicate with the UE using the first set of one or more default beams during at least one symbol period of the one or more full-duplex symbol periods.

15. The apparatus of claim 14, wherein the first set of one or more default beams comprises one or more default downlink beams or one or more default uplink beams, each default downlink beam of the one or more default downlink beams or each default uplink beam of the one or more default uplink beams being associated with a respective transmission reception point.

16. The apparatus of claim 14, wherein the first set of one or more default beams comprises a default beam pair, the default beam pair comprising one default uplink beam and one default downlink beam, wherein the default beam pair comprising the one default uplink beam and the one default downlink beam is configured for the full-duplex communications with at least one transmission reception point during the at least one symbol period.

17. The apparatus of claim 14, wherein the control message comprises a radio resource control message, a medium access control-control element, downlink control information, or any combination thereof.

18. The apparatus of claim 14, wherein the instructions are further executable by the processor to cause the apparatus to:
determine a lowest control resource set index value in a latest slot that precedes the one or more full-duplex symbol periods based at least in part on the latest slot and the one or more full-duplex symbol periods both being configured for the full-duplex communications, wherein the first set of one or more default beams is identified based at least in part on a beam that is associated with a lowest control resource set index value.

19. The apparatus of claim 14, wherein the instructions are further executable by the processor to cause the apparatus to:
determine a lowest control resource set index value in a latest slot that precedes an uplink symbol period, a downlink symbol period, or a flexible symbol period based at least in part on the latest slot and the uplink symbol period, the downlink symbol period, or the flexible symbol period both being configured for time-division duplexed communications, wherein a second set of one or more default beams is identified based at least in part on a beam that is associated with a lowest control resource set index value.

20. A method for wireless communication, comprising:
selecting a first set of one or more default beams for full-duplex communications, the first set of one or more default beams being configured for communications with one or more transmission reception points during one or more full-duplex symbol periods; and
communicating with the one or more transmission reception points using the first set of one or more default beams during at least one symbol period of the one or more full-duplex symbol periods.
